(19) United States
(12) Patent Application Publication
(10) Pub. No.: US 2006/0165574 A1
(43) Pub. Date: Jul. 27, 2006

(54) Modified adsorbent for dry scrubbing and use thereof

(76) Inventor: Abdelhamid Sayari, Ottawa (CA)

Correspondence Address: DLA PIPER RUDNICK GRAY CARY US, LLP, 4365 EXECUTIVE DRIVE, SUITE 1100, SAN DIEGO, CA, 92121-2133, US

(21) Appl. No.: 10/539,225

(22) PCT Filed: Dec. 18, 2003
(86) PCT No.: PCT/CA03/01968

§ 371 Date: Dec. 7, 2005

(30) Foreign Application Priority Data
Dec. 18, 2002 (US) 60433967

(51) Int. Cl. B01D 53/46; B01J 20/00; B01D 47/00

(52) U.S. Cl. 423/210; 502/400

(57) ABSTRACT

The present invention provides an amine functionalised adsorbent for use in dry scrubbing process. The adsorbent comprises amine functionalised mesoporous silica in which the amine groups are present at or near the surface of the silica, including within the pore walls and channels of the silica. The present invention further provides methods of preparing the adsorbent and of using the adsorbent for the adsorption of CO₂ and/or other acid gases.

### FIELD OF THE INVENTION

The present invention pertains to the field of adsorbents and more particularly to the field of amine modified adsorbents for use in dry scrubbing processes.

### BACKGROUND

The use of gas scrubbing processes for environmental protection or for manufacturing of chemicals is widespread in industry (A. Kohl and R. Nielsen, “Gas Purification”, Chap. II, Gulf Publ. Co, TX, USA, 1997). Removal of various gaseous pollutants such as volatile organic compounds (VOC), NOₓ, SOₓ, HF, HCl, H₂S, CO₂, phosphine and arsine often takes place via wet scrubbing, typically in countercurrent towers using either pure solvents (e.g., water or oil) or solvents containing dissolved materials which may consist of bases (D. Thomas and J. Vanderschuren, Chem. Eng. Tech. 23 (2000) 449; H. Bai and A. C. Yeh, Ind. Eng. Chem. Res. 36 (1997) 2490), salts (S. Lynn, A. L. Schiozer, W. L. Jaecksch, R. Cos and J. M. Prausnitz, Ind. Eng. Chem. Res. 35 (1996) 4236) or oxidants (T. J. Overcamp, Environ. Sci. Technol. 33 (1999) 155; U.S. Pat. No. 5,527,517; T. W. Chien and H. Chu, J. Hazard. Mater. 80-(2000) 43). There are also “semi-dry” scrubbing processes using a slurry of solid particles which react with targeted, species in the gas phase, ideally in a spray tower (D. Eden and M. Luckas, Chem. Eng. Technol. 21 (1998) 1). Dry scrubbing of gaseous acids using finely divided solid sorbents such as calcium oxide, hydroxide or carbonate in a cyclone reactor was also found, at the laboratory scale, to be highly efficient, particularly when partial recirculation of the solid reactant is achieved (A. M. Fonseca, J. J. Orfao and R. L. Salcedo, Ind. Eng. Chem. Res. 40-(2001) 304).

Carbon dioxide scrubbing is currently used on a large scale for the purification of industrial gases (natural gas, syngas, etc.) and also in life support systems in confined space (submarines, space shuttle and other inhabited engines for space exploration). These processes use mainly alkanolamine aqueous solutions (G. Astarita, D. W. Savage and A. Bisio, Gas Treating with Chemical Solvents, John Wiley, NY, 1983), the most common being mono- and di-ethanolamines, (MEA and DMEA) and N-methyldiethanolamine (MDEA). The process is reversible and can be represented as follows:

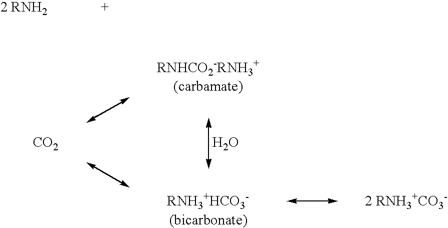

These reactions being exothermic, the formation of carbamate and bicarbonate is favoured at low temperature, while their dissociation to amine and CO₂ prevails at high temperature. The formation of one carbamate molecule requires two amine molecules, while a one-to-one ratio is required for bicarbonate. To maximise the CO₂ adsorption capacity, it is therefore important to either enhance the hydrolysis of carbamate or limit its formation.

In addition to the decreased capacity due to carbamate formation, the use of aqueous solutions of low molecular weight alkanolamines suffers a number of drawbacks (R. J. Hook, Ind. Eng. Chem. Res. 36 (1997) 1779; A. Veawab, P. Tontiwachwuthikul and A. Chakma, Ind. Eng. Chem. Res. 38 (1999) 3917); under scrubbing conditions, (i) a fraction of the amine and its decomposition products is lost by evaporation, which in addition to reducing the absorption capacity, may cause problems because of their toxicity, (ii) the amine undergoes oxidative degradation leading to decreased capacity, increased viscosity and excessive foaming, (iii) excessive corrosion takes place, thus posing severe operational problems.

Introduction in the mid-eighties of the so-called sterically hindered amines by Exxon (G. Sartori and D. W. Savage, Ind. Eng. Chem. Res. 22 (1983) 239) mitigated these problems to a great extent. Indeed, these amines were less corrosive, less volatile, and the corresponding carbamates were highly unstable. Actually, the most promising sterically hindered amine, namely 2-amino-2-methyl-1-propanol (AMP) does not yield any carbamate upon interaction with CO₂ at low temperature (A. K. Chakraborty, G. Astarita and KB. Bishoff, Chem. Eng. Sci. 41 (1986) 997). However, hindered amines exhibit lower rates of CO₂ absorption. The use of high-efficiency column internals such as structural packing, or high surface area membranes leads to improved mass transfer coefficients which compensate, at least partly, for the intrinsic low reactivity.

Dry scrubbing offers a viable alternative to the use of aqueous solutions. The use of dry scrubbing will reduce the amount of corrosion that occurs during the scrubbing process and the acute problems related to the disposal of large amounts of contaminated wastewater will also be eliminated. Only limited examples of dry scrubbing studies exist; mostly dealing with absorption of acid gases by hydrated lime. In this case, there is incomplete utilisation of the adsorbent because of the increasing barrier of diffusion within the adsorbent particles. In addition to liquid phase systems that make use of amines, there have been attempts to use solid amines, particularly for air revitalisation in manned space shuttles. Two recent patents disclose the use solid impregnated amines for cyclical adsorption of CO₂ (U.S. Pat. Nos. 5,376,614 and 5,876,488).

A need remains for an adsorbent material for use in dry scrubbing processes that exhibits high capacity for acid gas adsorption and high acid gas adsorption rates.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a modified support for dry scrubbing and use thereof. In accordance with an aspect of the present invention, there is provided an adsorbent comprising an amine-functionalised mesoporous silica.

In accordance with another aspect of the present invention, there is provided a water-tolerant, regenerable adsorbent for use in an acid gas dry scrubbing process, said adsorbent comprising surface or framework amine-functionalised mesoporous silica or organosilica, wherein amino groups are readily accessible within the pore channels or pore wall s of the mesoporous silica or organosilica.

In accordance with another aspect of the invention, there is provided a regenerable adsorbent comprising an amine-functionalised mesoporous silica or organosilica for use in dry scrubbing, wherein the mesoporous silica contains amine groups that are covalently bound to the surface of the silica.

In accordance with another aspect of the invention, there is provided a regenerable adsorbent comprising an amine-functionalised mesoporous silica or organosilica for use in dry scrubbing, wherein the mesoporous silica has a hydrophobic surface and contains amine groups that are dispersed within the hydrophobic surface.

In accordance with another aspect of the invention, there is provided a regenerable adsorbent comprising an amine-functionalised mesoporous silica or organosilica for use in dry scrubbing, wherein the mesoporous silica is prepared-using amine-containing amphiphile molecules.

In accordance with another aspect of the invention, there is provided a regenerable adsorbent comprising an amine-functionalised mesoporous silica or organosilica for use in dry scrubbing, wherein the mesoporous silica comprises an amine-functionalised framework.

In accordance with another aspect of the invention, there is provided a method of dry scrubbing comprising the step of contacting a gaseous stream containing an acid gas to be removed with a regenerable adsorbent comprising an amine-functionalised mesoporous silica or organosilica.

In accordance with another aspect of the invention, there is provided a system for removal of an acid gas from a gaseous stream, comprising: two or more sorbent beds comprising an amine-functionalised mesoporous silica or organosilica; valve means for controlling gas flow through the sorbent beds; and pump means for controlling gas pressure in the system.

### BRIEF DESCRIPTION OF THE FIGURES

FIG. 1 is a schematic view of the pore structure of a typical mesoporous silica.

FIG. 2 depicts two general processes for the preparation of amine surface functionalised mesoporous silica.

FIG. 3 depicts two general processes for the preparation of amine surface functionalised mesoporous silica via mesoporous silica that has been surface modified to contain non-amine reactive organic substituents.

FIG. 4 depicts two general processes for the preparation of mesoporous silica containing supported amines.

FIG. 5 depicts general processes for the preparation of hexagonal mesoporous silica (HMS) silica, MSU-V and MSU-G.

FIG. 6 depicts two general processes for the preparation of amine-filled mesoporous silica using an amine-modified swelling agent.

FIG. 7 depicts two general processes for the preparation of mesoporous silica containing an amine-functionalised framework.

FIG. 8 is a schematic representation of the basic components of a continuous adsorption/desorption system according to one embodiment of the present invention.

FIG. 9 is a schematic representation of a continuous CO₂ adsorption/desorption system comprising an adsorption column 1, a desorption column 2, a CO₂ monitor 3, a vacuum 6, a plurality of solenoid valves 7 and computer means 8 for control and data acquisition. The feed gas mixture is identified by reference number 4 and the purge gas by reference number 5.

### DETAILED DESCRIPTION OF THE INVENTION

The present invention provides an amine functionalised adsorbent for use in dry scrubbing. The adsorbent comprises an amine functionalised mesoporous organic-inorganic composite where all of the active functional groups-(amines) are located inside the pore channels and/or within the pore walls of the composite and are readily accessible to the adsorbate. It has now been found that the configuration of the adsorbent of the present invention allows adsorption of acidic gases, including but not limited to CO₂ and H₂S gas, at equivalent or higher rates, capacities and sensitivities than those obtainable using conventional liquid phase systems.

Since water is a ubiquitous impurity in gaseous streams, one embodiment of the present invention provides an adsorbent that has the additional characteristic of being water tolerant. The term “water tolerant,” is used herein to indicate that the presence of moisture in the gas mixture does not hamper the adsorption of CO₂, or other acidic gas, by the adsorbent. In a further embodiment of the present invention, the adsorbent has the additional characteristic of being capable of regeneration. The capacity for regeneration will allow the adsorbent to be used repeatedly, by first adsorbing the acid gas to be removed and subsequently stripping the adsorbent to free the amines for subsequent reuse.

Components of Adsorbent

The adsorbent of the present invention can be prepared using various methods, including those outlined herein, in order to obtain material having varying capacities and rates of adsorption depending on the potential use of the material. In each case the adsorbent comprises mesoporous silica or organosilica that has been modified to contain amines that are accessible to the adsorbate.

Mesoporous Silica

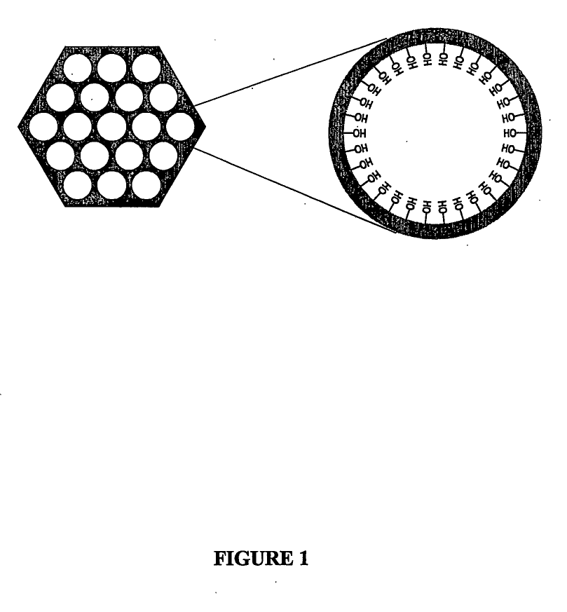

Mesoporous silicas and organosilicas are prepared in the presence of surfactants or polymer solutions via different pathways including the so-called cooperative organization mechanism (A. Firouzi, A. Monnier, L. M. Bull, T. Besier, P. Sieger, Q. Huo, S. A. Walker, J. A. Zasadzinski, C. Glinka, J. Nicol, D. Margolese, G. D. Stucky and B. F. Chmelka, Science 267 (1995) 1138) and the liquid crystal templating mechanism (G. A. Attard, J. C. Glyde and C. G. Göltner, Nature 378 (1995) 366). They may exhibit different structures and pore systems, the most prominent being the so-called MCM-41 with a two-dimensional hexagonal symmetry. Table 1 provides a non-limiting list of mesoporous silicas and organosilicas, prepared under different pH conditions using different amphiphile molecules, that can be used in the adsorbent of the present invention. The pore size of such material may be adjusted from a low of 1 nm to well into the macropore regime, i.e. >50 nm (A. Sayari, M. Kruk, M. Jaroniec and I. L. Moudrakovski, Advanced Materials, 10 (1998) 1376; A. Sayari, Y. Yang, M. Kruk and M. Jaroniec, J. Phys. Chem. B 103 (1999) 3651; and A. Sayari, Angewandte Chemie, 39 (2000) 2920). They are thermally very stable and their surface area routinely exceeds 1000 m²/g. As shown in FIG. 1, under proper hydration conditions, the inner surface, which represents approximately 95% of the total surface, is covered with OH groups that can be used to anchor a variety of surface modifiers. Comprehensive reviews on this subject are available in the literature (A. Stein, B. J. Melde and R. C. Schroden, Adv. Mater. 12 (2000) 1403 and A. Sayari and S. Hamoudi, Chem. Mater., invited review, 2001).

TABLE 1
Mesoporous Silicas and Organosilicas

| Meso- | Amphiphile | | | |
|---|---|---|---|---|
| phase | template | pH | Structure | Reference |
| MCM-41 | CₙH₂ₙ₊₁(CH₃)₃N⁺ | basic | 2D hexagonal | [1] |
| | | | (p6 mm) | |
| MCM-48 | CₙH₂ₙ₊₁(CH₃)₃N⁺ | basic | cubic | [1] |
| | Gemini Cₙ₋ₛ₋ₙ^{a} | | (Ia\overline{3}d) | [2] |
| FSM-16 | C₁₆H₃₁(CH₃)₃N⁺ | basic | 2D hexagonal | [3] |
| | | | (p6 mm) | |
| SBA-1 | C₁₈H₃₇N(C₂H₅)₃⁺ | acidic | cubic | [2] |
| | | | (Pm\overline{3}n) | |
| SBA-2 | Divalent Cₙ₋ₛ₋₁^{b} | acidic/ | 3D hexagonal | [2] |
| | | basic | (P6₃/mmc) | |
| SBA-3 | CₙH₂ₙ₊₁(CH₃)₃⁺ | acidic | 2D hexagonal | [4] |
| | | | (p6mm) | |
| SBA-6 | Divalent 18B₄₋₃₋₁^{c} | basic | cubic | [5] |
| | | | (Pm\overline{3}n) | |
| SBA-8 | Bolaform^{d} | basic | 2D | [6] |
| | | | rectangular | |
| | | | (cmm) | |
| SBA-11 | Brij ® 56; C₁₆EO₁₀ | acidic | cubic | [7] |
| | | | (Pm\overline{3}m) | |
| SBA-12 | Brij ® 76; C₁₈EO₁₀ | acidic | 3D hex. | [7] |
| | | | (P6₃/mmc) | |
| SBA-14 | Brij ® 30; C₁₂EO₄ | acidic | cubic | [7] |
| SBA-15 | P123; | acidic | 2D hexagonal | [8] |
| | EO₂₀PO₇₀EO₂₀ | | (p6 mm) | |
| SBA-16 | F127; | acidic | cubic | [7] |
| | EO₁₀₆PO₇₀EO₁₀₆ | | (Im\overline{3}m) | |
| FDU-1 | B50-6600; | acidic | cubic | [9] |
| | EO₃₉BO₄₇EO₃₉ | | (Im\overline{3}m) | |
| FDU-2 | RN⁺N⁺N^{+e} | basic | cubic | [10] |
| | | | (Fd3m) | |
| MSU-1 | Tergitol; C₁₁₋₁₅(EO)₁₂ | neutral | disordered | [11] |
| | TX-114; | | | |
| MSU-2 | C₈Ph(EO)₈ | neutral | disordered | [11] |
| | TX-100; | | | |
| | C₈Ph(EO)₁₀ | | | |
| MSU-3 | P64L; | neutral | disordered | [11] |
| | (EO₁₃PO₃₀EO₁₃) | | | |
| MSU-4 | Tween ®-20, 40, | neutral | disordered | [12] |
| | 60, 80 | | | |
| MSU-V | H₂N(CH₂)ₙNH₂ | neutral | lamellar | [13] |
| MSU-G | CₙH₂ₙ₊₁NH(CH₂)₂ | neutral | lamellar | [14] |
| | NH₂ | | | |
| HMS | CₙH₂ₙ₊₁NH₂ | neutral | disordered | [15] |
| Meso- | P123 + TMB^{f} | acidic | disordered | [16] |
| cell- | | | | |
| ular | | | | |

EO = ethylene oxide;
PO = propylene oxide
(a) Gemini surfactants Cₙ₋ₛ₋ₙ: CₙH₂ₙ₊₁N⁺(CH₃)₂(CH₂)ₛN⁺(CH3)₂CₙH₂ₙ₊₁.
(b) Divalent surfactants Cₙ₋ₛ₋₁: CₙH₂ₙ₊₁N⁺(CH₃)₂(CH₂)ₛN⁺(CH₃)₃.
(c) Divalent surfactant 18B₄₋₃₋₁: C₁₈H₃₇O—C₆H₄—O(CH₂)₄N⁺(CH₃)₂(CH₂)₃N⁺(CH₃)₃.
(d) Bolaform surfactants: (CH₃)₃N⁺(CH₂)ₙO—C₆H₄—C₆H₄—O(CH₂)ₙN⁺(CH₃)₃.
(e) Tri-head group surfactant: C₁₆H₃₃N⁺(CH₃)₂(CH₂)₂N⁺(CH₃)₂(CH₂)₃N⁺(CH₃)₃
(f) Pluronic ® P123 (EO₂₀P₇₀EO₂₀) plus trimethylbenzene (TMB)
[1] J. S. Beck, J. C. Vartuli, W. J. Roth, M. E. Leonowicz, C. T. Kresge, K. D. Schmitt, C. T-W. Chu, D. H. Olson, E. W. Sheppard, S. B. McCullen, J. B. Higgins and J. L. Schlenker, J. Am. Chem. Soc. 114 (1992) 10834.
[2] Q. Huo, R. Leon, P. M. Petroff and G. D. Stucky, Science 268 (1995) 1324.
[3] T. Yanagisawa, T. Shimizu, K. Kuroda and C. Kato, Bull. Chem. Soc. Jpn. 63 (1990) 988.
[4] Q. Huo, D. I. Margolese and G. D. Stucky, Chem. Mater. 8 (1996) 1147.
[5] Y. Sakamoto, M. Kaneda, O. Terasaki, D. Zhao, J. M. Kim, G. D. Stucky, H. J. Shin and R. Ryoo, Nature 408 (2000) 449.
[6] D. Zhao, Q. Huo, J. Feng, J. Kim, Y. Han and G. D. Stucky, Chem. Mater. 11 (1999) 2668.
[7] D. Zhao, Q. Huo, J. Feng, B. F. Chmelka and G. D. Stucky, J. Am. Chem. Soc. 120 (1998) 6024.
[8] D. Zhao, Q. Huo, J. Feng, B. F. Chmelka and G. D. Stucky, Science 279 (1998) 548.
[9] C. Yu, Y. Yu and D. Zhao, Chem. Commun. (2000) 575.
[10] S. Shen, Y. Li, Z. Zhang, J. Fan, B. Tu, W. Zhou and D. Zhao, Chem Commun. (2002) 2212.
[11] S. A. Bagshaw, E. Prouzet and T. J. Pinnavaia, Science 269 (1995) 1242.
[12] E. Prouzet, F. Cot, G. Nabias, A. Larbot, P. Kooyman and T. J. Pinnavaia, Chem. Mater. 11 (1999) 1498.
[13] P. T. Tanev, Y. Liang and T. J. Pinnavaia, J. Am. Chem. Soc. 119 (1997) 8616.
[14] S. S. Kim, W. Zhang and T. J. Pinnavaia, Science 282 (1998) 1302.
[15] P. T. Tanev and Pinnavaia, Science 267 (1995) 865.
[16] P. Schmidt-Winkel, W. W. Lukens, Jr., D. Zhao, P. Yang, B. F. Chmelka and G. D. Stucky, J. Am. Chem. Soc. 121 (1999) 254.

Mesoporous silica is prepared using standard techniques (Table 1) known to those skilled in the art, for example, in the presence of alkyltrimethylammonium surfactants using literature procedures (A. Sayari, Stud. Surf. Sci. Catal. 102 (1996) 1-46). Different methods for pore size engineering can be used, including, but not limited to the use of auxiliary organic molecules such as trimethylbenzene (J. S. Beck, J. C. Vartuli, W. J. Roth, M. E. Leonowicz, C. T. Kresge, K. D. Schmitt, C. T-W. Chu, D. H. Olson, E. W. Sheppard, S. B. McCullen, J. B. Higgins and J. L. Schlenker, J. Am. Chem. Soc. 114 (1992) 10834), the post-synthesis treatment with long chain tertiary amines (A. Sayari, M. Kruk, M. Jaroniec and I. L. Moudrakovski, Advanced Materials, 10 (1998) 1376; A. Sayari, Y. Yang, M. Kruk and M. Jaroniec, J. Phys. Chem. B 103 (1999) 3651; A. Sayari, Angewandte Chemie, 39 (2000) 2920) or the use of selected surfactants (R. Ryoo, et al., J. Amer. Chem. Soc. 123 (2001) 1650).

Following the initial preparation steps, the mesoporous silica or organosilica can be calcined or extracted to remove surfactant and, if necessary, characterised using X-ray diffraction, N₂ adsorption, scanning electron microscopy, and/or transmission electron microscopy.

Mesoporous silicas or organosilicas that are suitable for use in the present invention exhibit high surface areas to enable high loading of adsorption sites, and provide sufficiently large pores to enable relatively unhindered flow of CO₂, or other acid gas, containing gaseous streams inside the pore system.

Amines

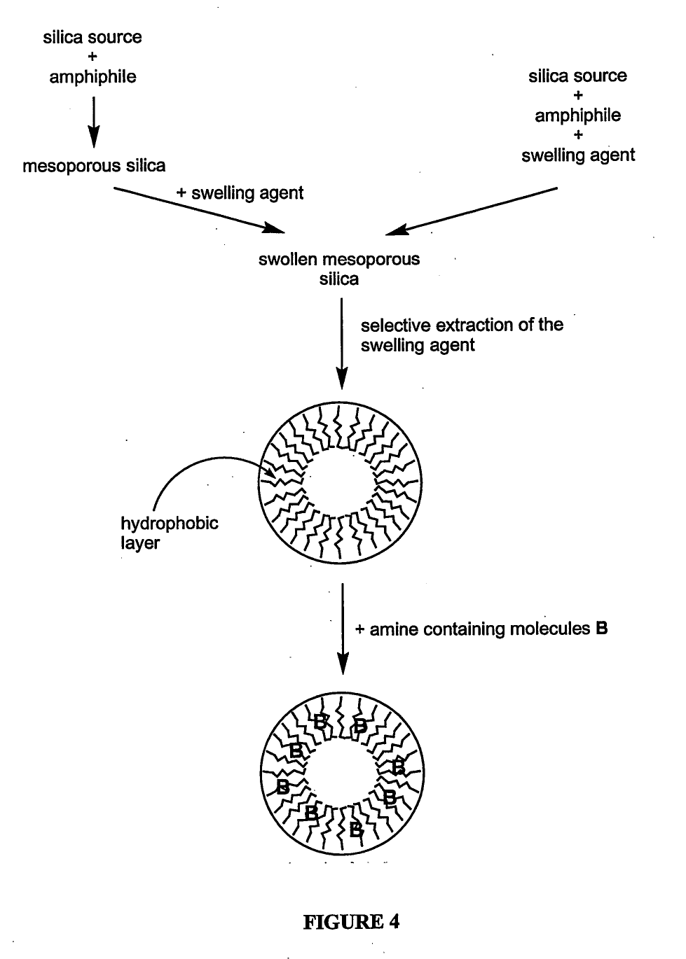

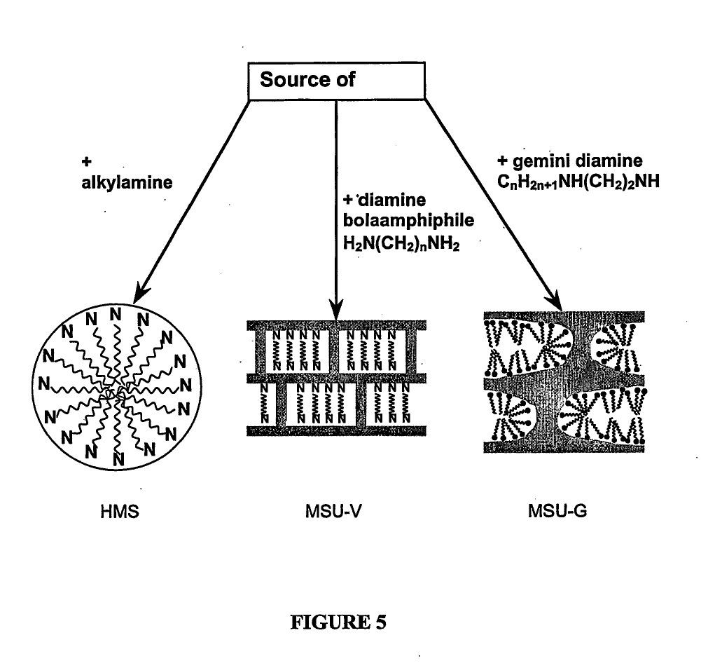

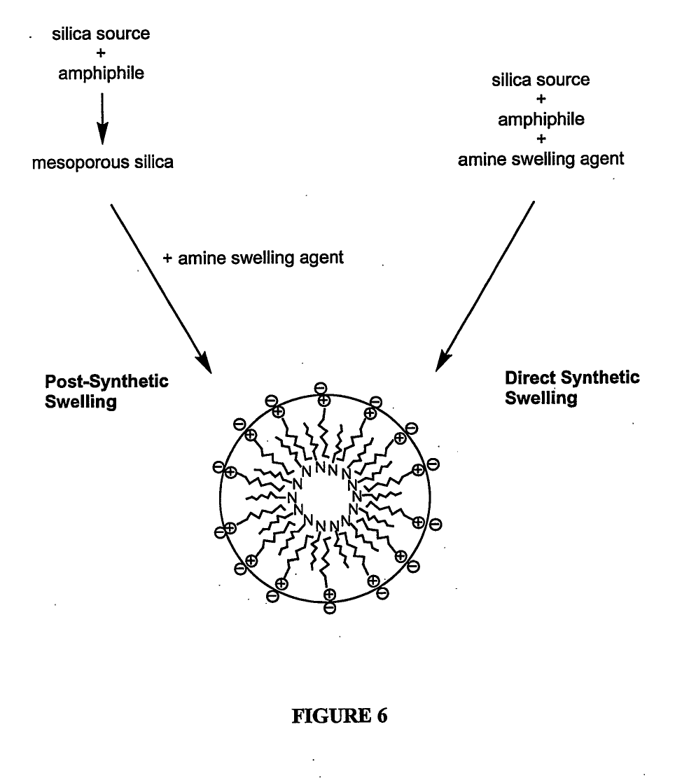

The amines used in the preparation of the adsorbent of the present invention must exhibit sufficient basicity to allow for efficient reaction with CO₂, or other acidic acid to be adsorbed. In addition a high N/C ratio can be beneficial to maximising the concentration of amine groups added to the mesoporous silica. In order to allow effective regeneration of the adsorbent, the adsorbent should be thermally stable during the desorption process. In cases where the amine is held by Van der Waals forces (e.g. FIGS. 4 and 6) or hydrogen bonding (e.g. FIG. 5), the amine should have relatively low volatility to ensure that the amine remains attached to the adsorbent during desorption processes.

The amines may be primary amines, secondary amines, tertiary amines, mixed amines or any combination thereof. As shown in the following section, amines can be introduced via different routes including (i) grafting or co-condensation using amine-containing trialkoxy- or trichlorosilanes, (ii) adsorption, (iii) synthesis or post-synthesis pore expansion using amines, (iv) reaction with framework or with pending reactive groups, and (v) self assembly with silica or organosilica precursors using amphiphile amines.

Selection of the specific amine or amines to be used in the preparation of the adsorbent of the present invention will depend on the configuration of the adsorbent and on the application for which the adsorbent is intended. For example, in cases where a high adsorptive-capacity is not required then the amine or amines will be selected keeping in mind characteristics such as high regeneration ability, low cost and ready availability rather than maximum reactivity. In general, primary and secondary amines are more reactive with acidic gases than tertiary amines. Similarly, primary amines are generally more reactive than secondary amines. As described below, the configuration of the adsorbent may impose limitations on the nature of the amine that can be used. Any amine-containing trialkoxy- or trichlorosilane may be used for co-condensation or post-synthesis grafting. However, adsorption of amine within the hydrophobic layer of mesoporous silica of organosilica offers the widest range of possible amines to be used. In the situations in which amines are used as supramolecular templates, it is necessary for the amines to have the ability to self assemble. Suitable amines for use as supramolecular templates include, but are not limited to, long chain alkylamines, Gemini diamines or bolaamphiphile amines. Similarly, amines used as pore expansion reagents should preferably have at least one long organic chain (A. Sayari, Y. Yang, M. Kruk and M. Jaroniec, J. Phys. Chem. B. 103 (1999) 3651).

Synthesis of Adsorbent

The use of various synthetic methods allows the production of adsorbents having different characteristics for use in diverse applications. Once prepared the adsorbent may be characterised in terms of pore structure and surface coverage using standard techniques.

I. Amine Surface Functionalised Mesoporous Silica

In accordance with one embodiment of the present invention the adsorbent is prepared such that the surface of the mesoporous silica is chemically modified to contain covalently attached amino groups.

1. Amine Surface Functionalised Silica

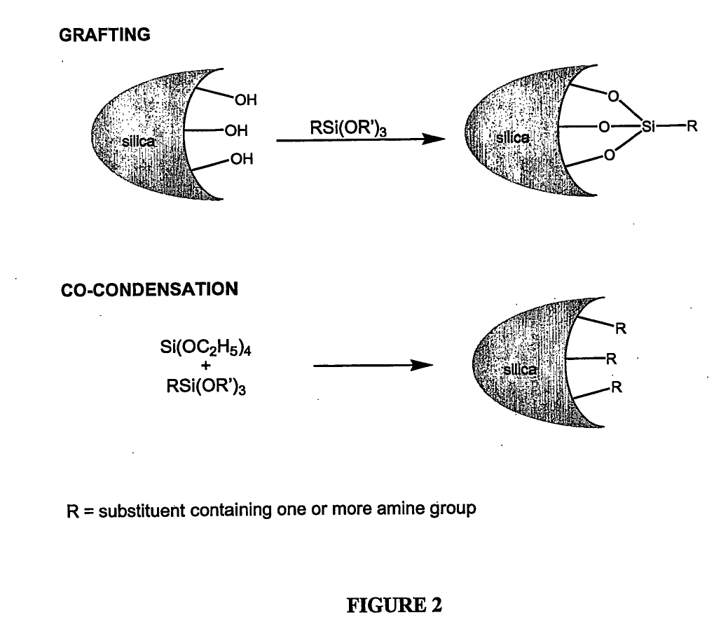

In a specific embodiment of the present invention, following preparation of the mesoporous silica, surface functionalisation is performed by post-synthetic grafting of an amine-containing trialkoxysilane to the surface of the mesoporous silica as depicted in FIG. 2. Alternatively, surface functionalisation is achieved by direct synthesis through co-condensation of an amine-containing trialkoxysilane with tetraalkoxysilane or bridged silsesquioxane molecules (R′O)₃Si—R—Si(OR′)₃, where R is an organic linker, according to the co-condensation process generally depicted in FIG. 2. The material is obtained by standard supramolecular templating techniques using the mixture of precursors.

This type of adsorbent is referred to herein as a Type I-1 adsorbent.

The following is a non-limiting list of amines that may be used in the preparation of the adsorbent of the present invention via post-synthesis grafting or via co-condensation (FIG. 2).

| AMINE FORMULA | CHEMICAL NAME |
|---|---|
| Primary Amines | |
| NH₂—(CH₂)₃—Si(OC₂H₅)₃ | aminopropyl- |
| | triethoxysilane |
| NH₂—(C₆H₄)—Si(OCH₃)₃ | p-aminophenyltri- |
| | methoxysilane |
| NH₂—(C₆H₄)—O—(CH₂)₃—Si(OCH₃)₃ | 3(m-amino- |
| | phenoxy)propyl- |
| | trimethoxysilane |
| Secondary Amines | |
| CH₃—NH—CH₂—CH₂—CH₂—Si(OCH₃)₃ | N-methylaminopropyl- |
| | trimethoxysilane |
| (C₆H₅)—NH—CH₂—CH₂—CH₂—Si(OCH₃)₃ | N-phenylaminopropyl- |
| | trimethoxysilane |
| Tertiary Amines | |
| (CH₃)₂N—CH₂—CH₂—CH₂—Si(OCH₃)₃ | N,N-dimethyl |
| | aminopropyltri- |
| | methoxysilane |
| (C₂H₅)₂N—CH₂—CH₂—CH₂—Si(OCH₃)₃ | N,N-diethyl |
| | aminopropyltri- |
| | methoxysilane |
| [HO—(CH₂)₂]₂N—(CH₂)₃—Si(OCH₃)₃ | Bis(2-hydroxy- |
| | ethyl)3-aminopropyl- |
| | trimethoxysilane |
| Mixed Diamine | |
| NH₂—(CH₂)₂—NH—(CH₂)₃—Si(OCH₃)₃ | N-(2-aminoethyl)- |
| | 3aminopropyltri- |
| | methoxysilane |

2. Surface Functionalised Silica Modified by Amines

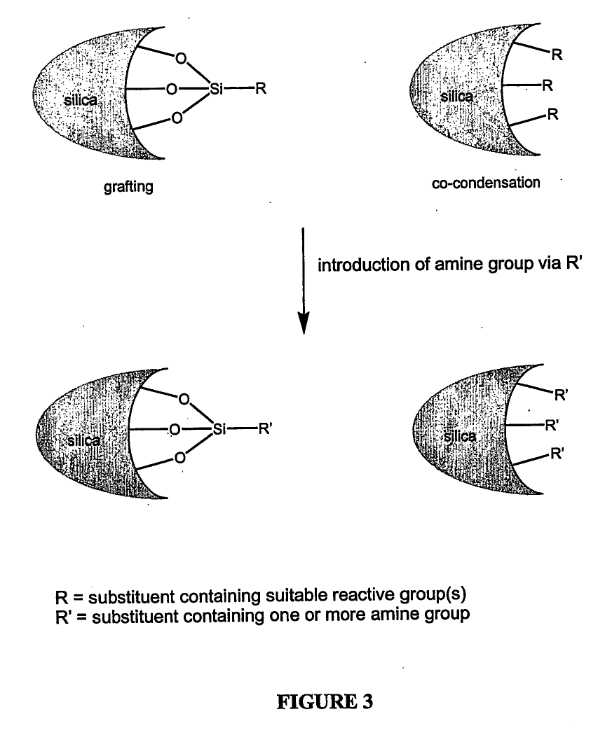

In an alternative embodiment of the present invention, the adsorbent is prepared using mesoporous silica or organosilica that has been functionalised using a reactive organic substituent capable of amine modification. One example of a suitable organic group is an unsaturated carbon-carbon bond, which may be provided via a substituent such as vinyl, allyl, ethynyl and propargyl. The suitable reactive substituent may be introduced onto the surface of the silica using post-synthetic grafting procedures or through co-condensation using appropriate starting materials as illustrated in FIG. 3. This type of adsorbent is referred to herein as a Type I-2 adsorbent.

II. Mesoporous Silica Containing Supported Amines

In accordance with another embodiment of the present invention the adsorbent comprises amines that are supported on mesoporous silica or organosilica having a hydrophobic surface. Suitable amines for use in the preparation of this adsorbent include, but are not limited to, alkylamines, such as monoethanolamine (MEA), diethanolamine (DEA), diisopropylamine (DIP), N-methyldiethanolamine (MDEA), 2-amino-2-methyl-1-propanol (AMP), polyethylenimine and β,β′-hydroxyaminoethylether, arylamines, alkylarylamines and mixtures thereof. The hydrophobic silica is obtained via pore size expansion of any silica mesophase such as MCM-41, MCM-48, SBA-n, MSU-n, etc (Table 1) in the presence of a swelling agent followed by selective extraction of the swelling agent in the presence of suitable solvents. The pore expansion may be carried out through direct synthesis in the presence of swelling agents such as long chain amines, hydrocarbons and trimethylbenzene, or via post-synthesis treatment in the presence of swelling agents such as N,N-dimethylalkylamines, as generally depicted in FIG. 4.

Introduction of an amine-containing molecule to the expanded-extracted mesoporous silica results in the amine-containing molecule being dispersed on and within the hydrophobic surface of the pores of the silica. This type of adsorbent is referred to herein as a Type II adsorbent.

III. Amine-Filled Mesoporous Silica

In accordance with an additional embodiment of the present invention, the adsorbent is prepared using standard procedures for the preparation of mesoporous silica in which one or more of the reagents have been modified to contain reactive amino groups. Specific examples of this embodiment (Table 1) include hexagonal mesoporous silica (HMS; P. T. Tanev and Pinnavaia, Science 267 (1995) 865), MSU-V (P. T. Tanev, Y. Liang and T. J. Pinnavaia, J. Am. Chem. Soc. 119 (1997) 8616) and MSU-G (S. S. Kim, W. Zhang and T. J. Pinnavaia, Science 282 (1998) 1302). HMS is prepared using alkylamines (CₙH₂ₙ₊₁NH₂, n=10-22) as the amphiphile molecule templates. MSU-V is prepared using diamine bolaamphiphiles (H₂N(CH₂)ₙNH₂, n=10-22) as supramolecular templating molecules. MSU-G is prepared using Gemini diamines (CₙH₂ₙ₊₁NH(CH₂)₂NH₂, n=10-22) as templates. A diagrammatic representation of the synthesis of amine-filled mesoporous silicas HMS, MSU-V and MSU-G is provided in FIG. 5. This type of adsorbent is referred to herein as Type III-1 adsorbent.

Another example of such an amine-filled mesoporous silica is referred to as amine-swollen silica (Type III-2 in Tables 3 and 4). In this case the adsorbent is prepared using standard techniques in which the swelling agent has been modified to contain one or more type of reactive amino group. As shown in FIG. 6, the amine-modified swelling agent may be used in a post-synthetic swelling procedure or in a direct synthetic swelling procedure for the preparation of the amine-filled mesoporous silica.

IV. Mesoporous Organosilica with Amine-Functionalised Framework

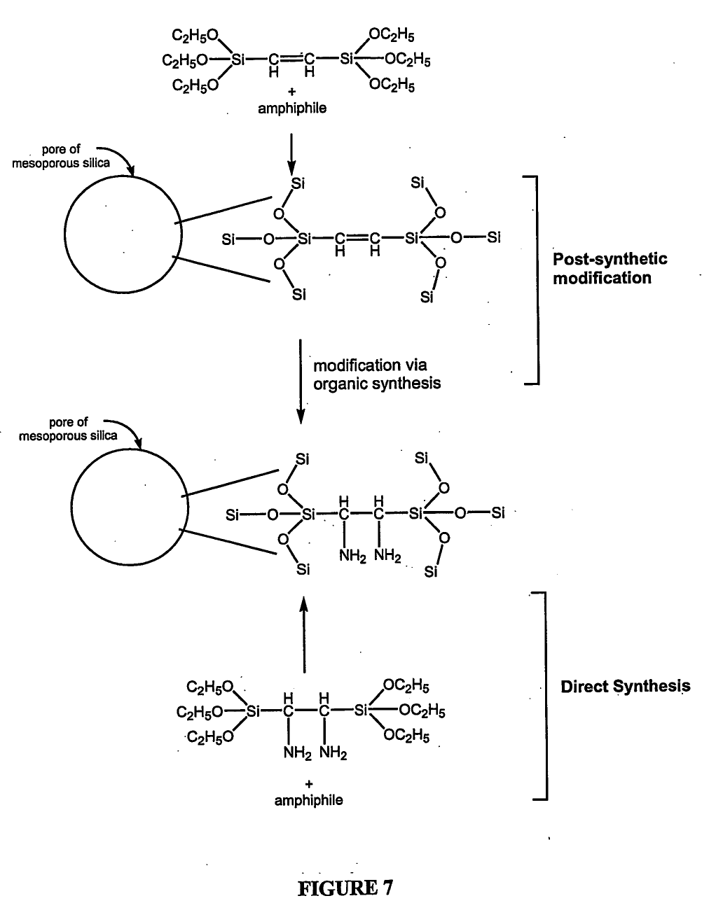

In another embodiment of the present invention, the adsorbent is a mesoporous organosilica in which an organic functionality is incorporated into the framework of the silica. The raw material is a mesoporous organosilica of the general formula (_{1.5}OSi—R—SiO_{1.5}) with a suitable organic linker, R, comprising a reactive group such as an unsaturated carbon-carbon bond. Examples of such linkers are ethylene and acetylene. For example, mesoporous ethylenesilica is prepared via condensation of bis-ethylenetriethoxysilane ((C₂H₅O)₃Si—CH═CH—Si(OC₂H₅)₃) in the presence of an amphiphilic molecule (FIG. 7). This precursor can also be co-condensed with tetraethyl orthosilicate in any proportion. Subsequent reactions introduce as many amine functions as possible in order to maximise the adsorption capacity of the adsorbent, which is directly related to the number of amine groups per weight or volume unit of the final material. Similar adsorbents may be obtained via direct synthesis using amine-containing organosilica precursors (FIG. 7). This type of adsorbent is referred to herein as a Type IV adsorbent.

TABLE 2
Amine-functionalised Adsorbents

| Type | Sample ID | Silica Type | Amine |
|---|---|---|---|
| Type I | SA-117- | MCM41 | 3-amino-propyltriethoxysilane |
| | amine | | |
| | SA-128 | MCM41 | N-(3-(triethoxy- |
| | | | silyl)propyl)ethylenediamine |
| | SA-129 | MCM41 | dimethylaminopropyltrimethoxy- |
| | | | silane |
| | SA-130 | MCM41 | phenylaminopropyltrimethoxy- |
| | | | silane |
| | SA-140 | silica gel | 3-amino-propyltriethoxysilane |
| | SA-183 | MCM41 | 3-amino-propyltriethoxysilane |
| | SA-190- | MCM41 | 3-amino-propyltriethoxysilane |
| | amine | | |
| | DJ83C | SBA1 | 3-amino-propyltriethoxysilane |
| | SA-185- | SBA15 | 3-amino-propyltriethoxysilane |
| | amine | | |
| Type II | SA-124 | MCMEE | diethanolamine |
| | SA-126 | MCMEE | N-methyldiethanolamine |
| | SA-127 | MCMEE | diethanolamine |
| | SA-131 | MCMEE | diethanolamine |
| | PH-23 | MCM41EE | dodecylamine |
| | PH-27 | MCM41 | dibenzylamine |
| | PH-35 | MCM41EE | dipropylamine |
| | PH-47 | MCM41EE | dicyclohexylamine |
| | RF8L | MCM41EE | diethanolamine |
| | RF10L2 | MCM41EE | diethanolamine |
| | RF10L3 | MCM41EE | diethanolamine |
| | PH-65T | MCM41EE | trimethylamine |
| Type III-1 | HMS | MCM41 | 3-amino-propyltriethoxysilane |
| Type III-2 | RF-4E | MCM41E | dimethyldecylamine |
| | SA-50EED | MCM41E | Decylamine |

E = expanded
EE = expanded extracted

Use of Adsorbent

The present invention further provides a method and a system for removing CO₂ and/or other acid gases, such as H₂S, from a gaseous stream containing one or more of these gases. For simplicity, the following discussion specifically refers to CO₂ as the acid gas, however, it should be understood that the adsorbent can be used to remove any acid gas from a gaseous stream containing the acid gas.

Once the adsorbent has been synthesized, it can be employed in a sorbent bed for use in a cyclic adsorption process. To apply the adsorbent of the present invention to such a cyclic adsorption process, it must be formed into a stable, mechanically strong form. These forms may include, but are not limited to, powder forms, pellet forms and or monolithic structures or foams. In the case of pellet forms the adsorbent is mixed with a suitable inert or active secondary material as a binder. Criteria for selecting a suitable binder can include (i) achieving pellets or extrudates with minimum amount of binder; (ii) enhanced mechanical stability; (iii) preservation of adsorbent porosity and accessibility of adsorption sites; and (iv) affordability. For example, siloxanes and siloxane derivatives can be employed to form structured pellets, either extrudates or spheres, using the appropriate weight percentage of additive. The selection of the appropriate form and, if necessary, additive, is based on the application of the adsorbent and the type of equipment used in the dry scrubbing process. The selection and manufacture of the adsorbent form is well within the ordinary abilities of a worker skilled in the art.

Once the adsorbent form is selected and manufactured, it is used in a sorbent bed where a gaseous stream containing CO₂, and possibly water, contacts the adsorbent. The CO₂, water and amine chemically react to form an amine complex, thereby removing the CO₂ from the gaseous stream.

According to a specific embodiment of the present invention, once the adsorbent is loaded with CO₂ to a satisfactory level, for example, when greater than 80% of the amine has been converted to the amine complex, or at a designated cycle time, the sorbent bed can be regenerated. Regeneration comprises ceasing the flow of the gaseous stream through the bed and desorbing the adsorbed CO₂ and water. The endothermic desorption reaction is accomplished by thermal and/or pressure gradient means or by the use of a sweeping or purge gas, or any combination thereof. During this step, the amine complex is dissociated, CO₂ and water are removed and the amine is freed and ready for re-use.

It is understood that the adsorbent of the present invention is not limited to use for the removal of CO₂ from a gaseous stream. Rather the adsorbent can be used for the removal of any acid gas, or combination thereof, from a gaseous stream, provided that the acid gas (or gases) is capable of reaction with amines.

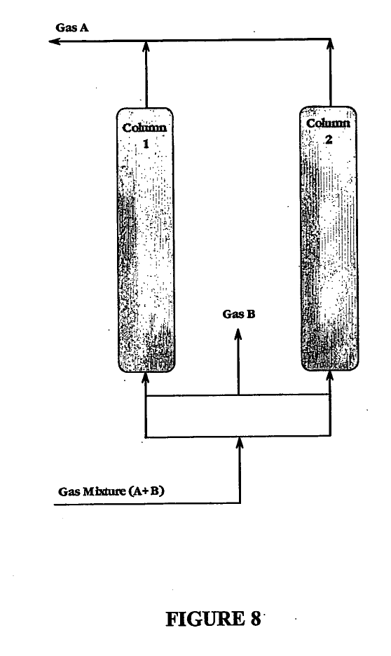

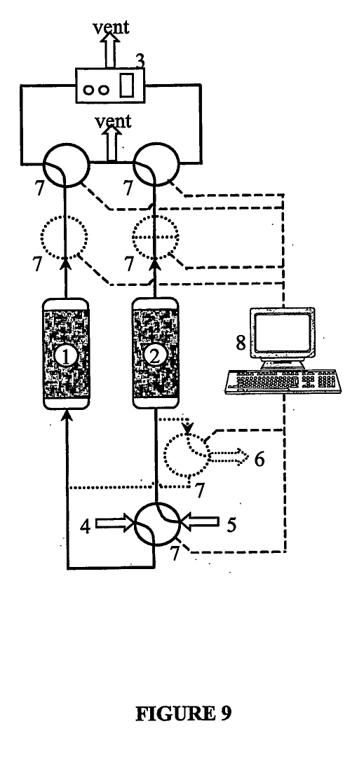

In one embodiment of the present invention, use of the adsorbent to remove CO₂, another acid gas, or a combination thereof, can comprise utilising two or more sorbent beds operating cyclically such that the first bed is in the adsorption cycle while the second bed is in the desorption cycle. A schematic of the basics of such a system is depicted in FIG. 8. This system comprises two or more sorbent beds and computer or manually controlled valves and pumps allowing for continuous CO₂ (or other acid-gas) removal from the gaseous stream. In the adsorption cycle, an exothermic reaction occurs between CO₂ in the gaseous stream, which is flowing through the adsorbent, and the amine present in the adsorbent, thereby adsorbing the CO₂ and forming an amine complex. In one embodiment of the present invention, the heat produced during the adsorption process in the first bed can be transferred via a heat exchanger to the second bed to drive the endothermic desorption of the adsorbed CO₂ and water simultaneously occurring therein. Alternatively, the desorption process can be effected through thermal and/or pressure gradient means independent of the adsorption process, or by the use of a purge gas. Depending on the regeneration procedure, the system shown in FIG. 8 may be used as a pressure of vacuum swing adsorption (PSA or VSA) unit, pressure and temperature swing adsorption (PTSA) unit or concentration swing adsorption unit. FIG. 9 depicts a specific example of such a system, which is an automated, dual column PSA or VSA system.

Improved PSA systems allow the use of the adsorbent of the present invention in small, efficient CO₂ scrubbing units suitable for air revitalisation in confined spaces (e.g. space shuttles and submarines). One example of an improved PSA system is based on the Pulsar™ technology developed by QuestAir Technologies (Burnaby, BC).

To gain a better understanding of the invention described herein, the following examples are set forth. It should be understood that these examples are for illustrative purposes only. Therefore, they should not limit the scope of this invention in any way.

### EXAMPLES

### Example 1

### Preparation of Type II Adsorbents

Several samples of Type II adsorbents according to the present invention were prepared, using the various techniques outlined herein. In particular, adsorbents were prepared that consist of mesoporous silica or organosilica containing supported amines.

One sample (SA-124) of adsorbent containing supported amine was prepared using 2 g of expanded-extracted MCM-41 material, which was added to a mixture containing 1 g of diethanolamine and 10 g of water. The mixture was stirred at room temperature for 2 hours and subsequently dried in an oven at 60° C. for 40 hours. The resulting weight increase was 35.9% (2 g→2.718 g).

A second sample (SA-126) of adsorbent containing supported amine was prepared using the same procedure as described for the first sample, except that N-methyl-diethanolamine (1 g) was used in place of diethanolamine. The resulting weight increase was 17.3% (2 g→2.345 g).

A third sample (SA-127) of adsorbent containing supported amine was prepared using the same procedure as described for the first sample, except that the mixture contained 2 g of diethanolamine rather than 1 g. The resulting weight increase was 85% (2 g→3.7 g).

A fourth sample (SA-131) of adsorbent containing supported amine was prepared using the same procedure as described for the first sample, except that the mixture contained 3 g of diethanolamine rather than 1 g. The resulting weight increase was 125% (2 g→4.5 g).

Additional samples were prepared in the same manner as SA-131, using either diethanolamine (RF10L) or other amines (PH-23, PH-27, PH-35, PH-47; see Table 4).

### Example 2

### Preparation of Type I Adsorbents

Several samples of Type I adsorbents according to the present invention were prepared, using the various techniques outlined herein. In particular, adsorbents were prepared that consist of amine surface functionalised mesoporous silica or organosilica.

Synthesis of MCM-41 mesoporous silica (SA-117) was accomplished according to the following procedure: 68.325 g of cetyltrimethylammonium bromide (CTAB) was added to a mixture containing 48.1 g of tetramethylammonium hydroxide (TIAOH) and 463.7 g of distilled water, after mixing under magnetic stirring for 30 min, 25 g of Cab-O-Sil™ (fumed silica) was added slowly to the solution. Stirring was maintained at room temperature for 1 h, the mixture was transferred into a Teflon-lined autoclave, which was the heated to 100° C. for 40 h. The MCM-41 material was obtained by filtration, washing with water, drying at ambient condition and calcination at 540° C. for 5 h. The surface area of this material was: 1205 m²/g, the pore size-3.8 nm and the pore volume 1.2 cm³/g.

One sample (SA-117-amine) of amine surface functionalised silica was prepared using calcined MCM-41 (SA-117) as starting material. 5 g of SA-117 was heated in an oven at 120° C. for 2 h to eliminate moisture. In a three-necked flask, 100 ml of anhydrous toluene was refluxed under N₂ flow. Then the moisture-free MCM-41 was transferred into this flask under stirring and the mixture was kept under reflux. 2.41 g (0.013 mol) of aminopropyltriethoxysilane (APTES) was added into this boiling mixture. The grafting procedure was maintained for 5 h. The powder was recovered by filtration, toluene-washing, and drying in air.

Another sample (SA-190) was prepared using the same steps as outlined above for SA-117-amine, except that 10 g of APTES was used rather than 2 g as for SA-117-amine.

Another sample (SA-128) of amine surface functionalised silica was prepared using 2 g of another calcined MCM-41 material (SA-108), which was added to 100 ml toluene that contained 0.01 mol (2.22 g) of N-[3-(trimethoxysily)propyl]-ethylenediamine. The mixture was stirred under reflux for 5 hours. The resulting solid was obtained by filtration and washed with toluene. The resulting weight increase was 34% (2 g→2.68 g).

Another sample (SA-129) of amine surface functionalised silica was prepared using the same method as SA-128, except that N,N-dimethylaminopropyltrimethoxysilane was grafted on the calcined MCM-41 rather than N-[3-(trimethoxysily)propyl]-ethylenediainine.

Another sample (SA-130) of amine surface functionalised silica was prepared using the same method as SA-128, except that N-phenylaminopropyltrimethoxysilane was grafted on the calcined MCM-41 rather than N-[3-(trimethoxysily)propyl]-ethylenediamine.

Synthesis of SBA-15 mesoporous silica (SA-185) was prepared as follows: 20 g of Pluronic® P123 surfactant was dissolved into 600 g of 2M HCl and 150 g of water at 35° C. by stirring overnight. 5.2 g of NaCl was added to the transparent solution and stirring was maintained for 30 min before adding 42.5 g of TEOS to this solution. Stirring was stop after 5 min. The mixture was put into an autoclave at 35° C. for 18 hour. Further ageing was performed at 80° C. for 2 days. After calcinations this material had a surface area of 454 m²/g and a pore size of 8.4 nm.

Another sample (SA-185-amine) of amine surface functionalised silica was prepared using calcined MCM-41 (SA-185) as starting material. 11 g of SA-185 was heated in an oven at. 120° C. for 2 h to eliminate moisture. In a three-necked flask, 400 ml of anhydrous toluene was refluxed under N₂ flow. Then the moisture-free MCM-41 was transferred into this flask under stirring and the mixture was kept under reflux. 2.41 g (0.013 mol) of APTES was added into this boiling mixture. The grafting procedure was maintained for 5 h. The powder was recovered by filtration, toluene-washing, and drying in air.

Another sample (SA-140) was prepared as described above for SA-185-amine using a commercial amorphous silica (Davisil™, 280 m²/g, 18 nm pores) instead of SBA-15.

The nitrogen content of all samples was determined experimentally using a EA1100 CHNS elemental analyzer.

### Example 3

### Production of Periodic Ethylene-Bridged Mesoporous Silica for Use in Preparation of Type IV Adsorbents

Periodic ethylene-bridged mesoporous silica (FIG. 7) was prepared using bis(triethoxysilyl)ethylene (BTSENE; (C₂H₅O)₃Si—CH═CH—Si(OC₂H₅)₃) as precursor. BTSENE was prepared via metathesis of vinyltriethoxysilane (VTES, CH₂═CH—Si(OC₂H₅)₃) according to Marciniec et al.'s method (B. Marciniec, H. Maciejewski, J. Gulinski and L. Rzejak J. Organomet. Chem. 362 (1989) 273). The corresponding ordered mesoporous material was prepared via supramolecular templating procedures under acid conditions as described hereafter.

In one preparation, 2 g of Brij® 76 ((C₁₈H₃₇(OCH₂CH₂)₁₀OH) or 1.92 g Brij® 56 ((C₁₆H₃₃(OCH₂CH₂)₁₀OH) was dissolved in 10 g of distilled water and 50 g of 2 M hydrochloric acid at 50° C. After complete dissolution, BTSENE (3.52 g) was added, and the mixture stirred at 50° C. for 20 h, followed by another 20 h period at 50° C. under static conditions. A white precipitate was recovered by filtration, washed thoroughly with water and dried. The surfactant was removed by two consecutive solvent extractions using 150 ml of ethanol and 2 g concentrated HCl for 1 g of sample at 50° C. for 5 h. The material prepared in the presence of Brij® 76 had a specific surface area of 840 m²/g. Its pore size and pore volume were 3.9 nm and 0.63 cm³/g, respectively. The material prepared in the presence of Brij® 56 had a specific surface area of 899 m²/g. Its pore size and pore volume were 3.5 nm and 0.58 cm³/g, respectively.

In a second reaction, 2 g of triblock polyalkylene oxide copolymer Pluronic® P123 (EO₇₀PO₂₀EO₇₀, EO=ethylene oxide, PO=propylene oxide) was dissolved in 15 g distilled water and 60 g 2M HCl. The mixture was stirred for one day at 35° C., then 3.6 g BTSENE was added. A white precipitate appeared. The mixture was kept at 35° C. for an additional and solvent extracted as described above. This material had a specific surface area of 676 m²/g. Its pore size and pore volume were 8.6 nm and 0.92 cm³/g, respectively.

The products of each of the above reactions are suitable for reaction with an amine-containing reagents in order to introduce amine functional groups at the ethylenic groups.

### Example 4

### Measurements of CO₂ Adsorption Capacity Using a Down-Flow Micro-Reactor System

Carbon dioxide adsorption data was obtained using a down-flow micro-reactor system connected to a gas chromatograph (GC) with a thermoconductivity detector (TCD). One gram of adsorbent was loaded in a glass reactor between two layers of glass wool. The sample was pre-treated in a constant N₂ flow (30 ml/min) at 100° C. for 3 hours before cooling to room temperature. A mixed gas comprising 3% (v/v) CO₂ in nitrogen was allowed to flow through the sample bed (3 cm in height). After one minute, a small amount of the outlet gas was injected through a 6-way valve with a sample loop into the GC column. Sampling continued at one minute intervals until the material was saturated, i.e. no further adsorption of CO₂ observed.

In the early stages of testing, all CO₂ was adsorbed and the TCD did not detect any, CO₂ in the outlet gas. As the adsorbent became saturated, more and more CO₂ was detected by the TCD, until the concentration of CO₂ detected by the TCD was equal to the concentration of CO₂ in the inlet gas. The total amount (adsorption capacity) of adsorbed CO₂ was then calculated.

Following the measurement of CO₂ adsorption capacity, the sample was regenerated to remove adsorbed CO₂ and thereby free the amine groups. This was accomplished by heating the CO₂-loaded sample under nitrogen at 60 to 100° C. for 3 to 4 hours. In all cases, the amount of CO₂ adsorbed on regenerated and fresh adsorbents were comparable.

The effect of the presence of water in the gas stream was also investigated. In this case, the 3% CO₂/N₂ mixture was passed through a water saturator before being allowed to flow through the adsorbent sample. The saturator temperature was maintained constant within a range of about 9-12° C.

The results of these studies are summarised in Table 3.

### Example 5

### Measurements of CO₂ Adsorption Capacity Using a Thermogravimetric Analyzer

Carbon dioxide adsorption capacity was measured using a thermogravimetric analyzer (TGA from TA Instruments, Q-500). The sample powder was loaded into the balance with an initial weight between 30-50 mg. The material was then regenerated in 90 sccm UHP N₂ (Praxair) to the desired temperature for a period of 1 hour. Next, the material was cooled by natural convection to an equilibrium temperature of 25° C. and a 5% CO₂/N₂ (Certified-Praxair) mixture was introduced at 90 sccm. The mixture was allowed to flow across the sample for a period of 1 hour. These steps were considered as a single adsorption cycle. The results obtained are given in Table 4.

The adsorption capacity of the most commonly employed adsorbent material, namely Zeolite 13X (supplied by UOP as fine powder), was included for comparison. Zeolite 13X was used after activation at different temperature. It is important to note that, unlike the adsorbent of the present invention, Zeolite 13X is a very poor adsorbent of CO₂ in the presence of moisture.

Table 4 summarizes a comparison between RF10L3, which is a DEA loaded expanded extracted MCM-41 silica, and Zeolite 13X after pre-treatment in air at different temperatures. It is clear that Zeolite 13X does not reach its full adsorption capacity unless it is pretreated at 350° C. or higher, whereas RF10L3 does not require any pre-treatment whatsoever. This is due to the fact that Zeolite 13X is strongly hydrophilic, and unless it is pretreated at high temperature, its pore system will be filled with water and, thus, not available for CO₂ adsorption. In contrast, RF10L3 is not only hydrophobic in nature, but also the CO₂ adsorption occurs via chemical reaction.

In order to determine the ability of the adsorbent to be reused, samples were subjected to successive adsorption-regeneration cycles while the adsorption capacity was monitored using the TGA instrument. The same two samples, namely RF10L3 and Zeolite 13×, were compared. Using RF10L3, the sample was first treated at 40° C. for 1 hour under flowing N₂, then for 1 hour under 5% CO₂/N₂ mixture. This cycle was repeated several times. The adsorption capacity at each adsorption stage is shown in Table 5. A similar experiment was carried out with the treatment (regeneration) step at 60° C. Sample 13X was first treated at 350° C. under N₂ and cooled to 60° C. before being cycled. The treatment at 350° C. was necessary in order to remove adsorbed H₂O from the Zeolite 13X. This step was not necessary for RF10L3.

The data provided in Table 5 demonstrates that, although it exhibits a high CO₂ adsorption capacity upon air treatment at 350° C., the adsorption capacity of Zeolite 13 X decreases rapidly from one cycle to the next. This is mostly due to the low temperature-purge regeneration. Since the adsorption process is exothermic, a quantity of energy must be added in order to remove the adsorbed components. Therefore, the cyclic data from Zeolite 13X shows that the regeneration-purge temperature of 60° C. is not sufficient for complete removal of the CO₂ adsorbed during the previous cycle. Moreover, residual water in the gas mixture may also adsorb within the zeolite pore system, thus contributing to the deterioration of the zeolite adsorptive properties towards CO₂.

In comparison to Zeolite 13X, it has been found that the adsorbent of the present invention does not exhibit such a significant decrease in adsorption capacity from one cycle to the next. As demonstrated by the data in Tables 4 and 5, the adsorbent identified as RF10L3 does not require a high temperature pre-treatment and can be used for a more adsorption-desorption cycles than Zeolite 13X.

All publications, patents and patent applications mentioned in this specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

TABLE 3
Use of Various Adsorbents for Adsorption of CO₂ from N₂: Microreactor Measurements

| | | | | | | | CO₂ | |
|---|---|---|---|---|---|---|---|---|
| | | | | Amine | | Temperature | Adsorption | |
| Sample | | Material | | | Content^{A} | Regeneration^{B} | Capacity^{C} | CO₂/N |
| ID | Type | Type | Synthetic Method | Compound | (mmol/g) | (° C.) | (cc(STP)/g) | Ratio^{D} |
| blank | | MCM41 | Calcined | — | 0.00 | 100 | 0 | — |
| SA-50Ex | | MCM41 | Calcined | — | 0.00 | 100 | 5.5 | NA. |
| | | | Expanded | | | | | |
| HMS | III-1 | MCM41 | Co-condensation | APTES | 4.02 | 100 | 909 | 0.11 |
| SA- | III-2 | MCM41E | Swelling | Decylamine | NA | 100 | 23.20 | NA. |
| 50EED | | | | | | | | |
| SA-117- | I-1 | MCM41 | Grafting | APTES | 1.57 | 100 | 13.00 | 0.37 |
| amine | | | | | 1.57 | 100R | 11.70 | 0.33 |
| | | | | | 1.57 | 100R + H₂O* | 14.40 | 0.41 |
| SA-128 | I-1 | MPM41 | Grafting | TEOSPED | 2.39 | 100 | 22.00 | 0.41 |
| | | | | | | 100R | 21.00 | 0.39 |
| SA-129 | I-1 | MCM41 | Grafting | DMAPTMOS | NA | 100 | 2.50 | NA |
| SA-130 | I-1 | MCM41 | Grafting | PAPTMOS | NA | 100 | 3.00 | NA |
| SA-124 | II | MCMEE | Adsorption | DEA | 2.78 | 60 | 32.40 | 0.52 |
| | | | | | 2.78 | 60R | 32.00 | 0.51 |
| | | | | | 2.78 | 60R + H₂O | 31.50 | 0.51 |
| | | | | | 2.78 | 60R + H₂O* | 35.00 | 0.56 |
| SA-127 | II | MCMEE | Adsorption | DEA | 4.38 | 60 | 55.00 | 0.56 |
| | | | | | 4.38 | 60R | 54.00 | 0.54 |
| | | | | | 4.38 | 60R + H₂O* | 55.00 | 0.56 |
| SA-131 | II | MCMEE | Adsorption | DEA | 4.97 | 60 | 66.80 | 0.60 |
| | | | | | 4.97 | 60R | 65.00 | 0.59 |
| SA-126 | II | MCMEE | Adsorption | N-MDEA | 1.75 | 60 | 9.00 | 0.23 |
| | | | | | 1.75 | 60R | 8.50 | 0.22 |
| | | | | | 1.75 | 60R + H₂O* | 9.00 | 0.23 |

^{A}As determined by elemental analysis on a fresh sample
^{B}Each step was performed on the original sample
^{C}As determined by a breakthrough curve analysis on a fixed bed with a 5%(v/v)CO₂/N₂ UHP gas mixture
^{D}Does not include the surfactant's contribution to the total nitrogen content for the co-adsorbed materials
APTES 3-amino-propyltriethoxysilane
DEA Diethanolamine
DMAPTMOS Dimethylaminopropyltrimethoxysilane
N-MDEA N-Methyldiethanolamine
PAPTMOS Phenylaminopropyltrimethoxysilane
TEOSPED N-(3-(triethoxysilyl)propyl)ethylenediamine
*Water vapor (saturated at 9-12° C.) was brought to contact with sample for 1 h before CO₂ adsorption.
R = regenerated

TABLE 4
Use of Various Adsorbents for Adsorption of CO₂ from N₂: TGA Measurements

| | | | | | | | CO₂ | |
|---|---|---|---|---|---|---|---|---|
| | | | | Amine | | Temperature | Adsorption | |
| | | Material | Synthetic | | Content^{A} | Regeneration^{B} | Capacity^{C} | CO₂/N |
| Sample ID | Type | Type | Method | Compound | (mmol/g) | (° C.) | (cc(STP)/g) | Ratio^{D} |
| RF8ACT | — | MCM41 | — | — | 0.00 | 100 | 0.92 | — |
| RF8EEC | — | MCM41EE | — | — | 0.00 | 100 | 0.61 | — |
| SA-140 | I-1 | Silica Gel | Grafting | APTES | 0.71 | 100 | 3.26 | 0.205 |
| DJ83C | I-1 | SBA1 | Grafting | APTES | 1.11 | 100 | 6.15 | 0.247 |
| SA-185 | I-1 | SBA15 | Grafting | APTES | 1.14 | 100 | 4.26 | 0.167 |
| amine | | | | | | | | |
| SA-117C | I-1 | MCM41 | Grafting | APTES | 1.51 | 100 | 11.19 | 0.331 |
| SA-183 | I-1 | MCM41 | Grafting | APTES | 1.32 | 100 | 6.19 | 0.209 |
| SA-190 | I-1 | MCM41 | Grafting | APTES | 1.88 | 100 | 19.31 | 0.458 |
| amine | | | | | | | | |
| RF-4E | III-2 | MCM41E | Swelling | DMDA | 1.46 | 100 | 6.11 | 0.187 |
| PH-23 | II | MCM41EE | Adsorption | Dodecylamine | 2.05 | 60 | 8.22 | 0.179 |
| PH-27 | II | MCM41EE | Adsorption | Dibenzylamine | 2.39 | 60 | 11.78 | 0.220 |
| PH-35 | II | MCM41EE | Adsorption | Dipropylamine | 2.67 | 60 | 14.59 | 0.243 |
| PH-47 | II | MCM41EE | Adsorption | Dicyclohexylamine | 1.38 | 60 | 5.35 | 0.173 |
| RF8L1 | II | MCM41EE | Adsorption | DEA | 4.24 | 40 | 23.33 | 0.246 |
| RF8L2 | II | MCM41EE | Adsorption | DEA | 4.86 | 60 | 38.10 | 0.350 |
| RF10L3 | II | MCM41EE | Adsorption | DEA | 5.62 | 25 | 42.83 | 0.340 |
| RF10L3 | II | MCM41EE | Adsorption | DEA | 5.59 | 40 | 44.28 | 0.353 |
| RF10L3 | II | MCM41EE | Adsorption | DEA | 5.52 | 60 | 44.85 | 0.362 |
| RF10L3 | II | MCM41EE | Adsorption | DEA | 5.42 | 80 | 44.06 | 0.363 |
| RF10L3 | II | MCM41EE | Adsorption | DEA | 5.38 | 100 | 42.30 | 0.351 |
| RF10L2 | II | MCM41EE | Adsorption | DEA | 5.71 | 60 | 47.15 | 0.368 |
| PH-65T | II | MCM41EE | Adsorption | Trimethylamine | 1.86 | 60 | 5.86 | 0.140 |
| UOP-1A | — | 13X | — | — | — | 25 | 25.25 | — |
| UOP-1B | — | 13X | — | — | — | 40 | 27.63 | — |
| UOP-1C | — | 13X | — | — | — | 60 | 30.26 | — |
| UOP-1D | — | 13X | — | — | — | 100 | 33.57 | — |
| UOP-1E | — | 13X | — | — | — | 150 | 37.90 | — |
| UOP-1F | — | 13X | — | — | — | 200 | 44.93 | — |
| UOP-1G | — | 13X | — | — | — | 350 | 56.54 | — |
| UOP-1H | — | 13X | — | — | — | 400 | 57.56 | — |

^{A}As determined by combined TGA-MS analysis
^{B}Temperature held for 1.0 hour with a 90 sccm UHP N₂ purge and then cooled to feed temperature
^{C}As determined by a TGA weight gain for the first adsorption pass at atmospheric pressure with a 90 sccm 5%(v/v) CO₂/N₂ UHP gas mixture
^{D}Does not include the surfactant's contribution to the total nitrogen content for the co-adsorbed materials
APTES 3-amino-propyltriethoxysilane
DEA Diethanolamine
DMDA Dimethyldecylamine

TABLE 5
Cyclic Adsorption Capacity Comparison

| | | Temperature | | CO₂ Adsorption | |
|---|---|---|---|---|---|
| | | Regeneration^{B} | Adsorption | Capacity^{C} | Difference from |
| Sample ID | Cycle Number | (° C.) | (° C.) | (cc(STP)/g) | Cycle 1 (%) |
| RF10L3 | 1 | 40 | 25 | 44.28 | — |
| | 2 | 40 | 25 | 43.15 | −2.57 |
| | 3 | 40 | 25 | 42.81 | −3.32 |
| | 4 | 40 | 25 | 42.49 | −4.05 |
| | 5 | 40 | 25 | 42.21 | −4.68 |
| RF10L3 | 1 | 60 | 25 | 44.85 | — |
| | 2 | 60 | 25 | 42.29 | −5.72 |
| | 3 | 60 | 25 | 40.41 | −9.90 |
| | 4 | 60 | 25 | 39.21 | −12.6 |
| | 5 | 60 | 25 | 37.30 | −16.8 |
| Zeolite 13X | 1 | 350 | 25 | 53.49 | — |
| | 2 | 60 | 25 | 43.97 | −17.8 |
| | 3 | 60 | 25 | 36.92 | −31.0 |
| | 4 | 60 | 25 | 29.88 | −44.1 |
| | 5 | 60 | 25 | 24.47 | −54.2 |

1. A water-tolerant, regenerable adsorbent for use in an acid gas dry scrubbing process, said adsorbent comprising surface or framework amine-functionalised mesoporous silica or organosilica, wherein amino groups are readily accessible within the pore channels or pore walls of the mesoporous silica or organosilica.

2. The adsorbent of claim 1, wherein the amine-functionalised mesoporous silica or organosilica comprises amine-containing molecules that are covalently bound to the surface of the pore walls.

3. The adsorbent of claim 2, wherein the amine-containing molecules are amine-containing trialkoxysilane or trichlorsilane.

4. The adsorbent of claim 1, wherein the pore walls of the amine-functionalised mesoporous silica or organosilica has a hydrophobic surface and amine-containing molecules are dispersed within the hydrophobic surface.

5. The adsorbent of claim 4, wherein the amine-containing molecules are alkylamines, arylamines or alkylarylamines.

6. The adsorbent of claim 5, wherein the alkylamines are selected from the group consisting of monoethanolamine (MEA), diethanolamine (DEA), diisopropylamine (DIP), N-methyldiethanolamine (MDEA), 2-amino-2-methyl-1-propanol (AMP), polyethylenimine, β,β′-hydroxyaminoethylether and combinations thereof.

7. The adsorbent of claim 1, wherein the mesoporous silica or organosilica comprises an amine-functionalised framework.

8. The adsorbent according to claim 1, wherein the acid gas is carbon dioxide.

9. A method of dry scrubbing comprising the step of contacting a gaseous stream containing an acid gas to be removed with water-tolerant, regenerable adsorbent comprising surface or framework amine-functionalised mesoporous silica or organosilica, wherein amino groups are readily accessible within the pore channels or pore walls of the mesoporous silica or organosilica.

10. The method according to claim 9, wherein the amine-functionalised mesoporous silica or organosilica comprises amine-containing molecules that are covalently bound to the surface of the pore walls.

11. The method according to claim 9, wherein the pore walls of the amine-functionalised mesoporous silica or organosilica has a hydrophobic surface and amine-containing molecules are dispersed within the hydrophobic surface.

12. The method according to claim 9, wherein the mesoporous silica or organosilica comprises an amine-functionalised framework.

13. A process for preparing an adsorbent according to claim 2 or 3, comprising:
(a) providing a mesoporous silica or organosilica; and
(b) grafting an amine-containing silane to the surface of the mesoporous silica or organosilica to produce the amine-functionalised mesoporous silica or organosilica.

14. A process for preparing an adsorbent according to claim 2 or 3, comprising:
(a) mixing a source of silica or organosilica, an amine-containing silane and an amphiphile molecule under conditions that facilitate self assembly to produce the amine-functionalised mesoporous silica or organosilica.

15. A process for preparing an adsorbent according to claim 2 or 3, comprising:
(a) providing a mesoporous silica or organosilica;
(b) grafting an reactive group-containing silane to the surface of the mesoporous silica or organosilica; and
(c) treating the reactive group-containing mesoporous silica or organosilica with an amine to produce the amine-functionalised mesoporous silica or organosilica.

16. A process for preparing an adsorbent according to claim 2 or 3, comprising:
(a) mixing a source of silica or organosilica, a reactive group-containing silane and an amphiphile molecule to produce the reactive group-containing mesoporous silica or organosilica; and
(b) treating the reactive group-containing mesoporous silica or organosilica with an amine to produce the amine-functionalised mesoporous silica or organosilica.

17. A process for preparing an adsorbent according to claim 4, comprising:
(a) preparing a mesoporous silica or organosilica in the presence of a swelling agent and selectively extracting the swelling agent to produce a hydrophobic layer on the surface of the mesoporous silica or organosilica; and
(b) treating the mesoporous silica or organosilica produced in step (a) with an amine to produce the amine-functionalised mesoporous silica or organosilica. (Original) A process for preparing an adsorbent according to claim 1, comprising:
(c) mixing a silica source with an amphiphilic molecule having at least one amino group under conditions that facilitate self assembly of the silica source and the amphiphile to produce the amine-functionalised mesoporous silica or organosilica,
wherein, the amine-functionalised mesoporous silica or organosilica is a mesoporous silica or organosilica having pores filled with amine-containing amphiphilic molecules.

18. A process for preparing an adsorbent according to claim 1, comprising:
(a) reacting a silica source with an amphilic molecule; and
(b) simultaneously or subsequently adding an amine-containing swelling agent.

19. A process for preparing an adsorbent according to claim 7, comprising:
(a) mixing a reactive group-containing silica source with an amphiphilic molecule to produce a mesoporous silica or organosilica having a framework comprising reactive sites; and
(b) introducing amino groups at the reactive sites to produce the amine-functionalised mesoporous silica or organosilica.

20. A system for removal of an acid gas from a gaseous stream, comprising:
(a) two or more sorbent beds comprising the adsorbent of claim 1;
(b) valve means for controlling gas flow through the sorbent beds; and;
(c) pump means for controlling gas pressure in the system.

21. The system according to claim 21, wherein the acid gas is carbon dioxide.

22. The system according to claim 21, wherein the adsorbent is pelletized with a binder that is an inert secondary material.

23. The system according to claim 21, wherein the adsorbent is pelletized with a binder that is an active secondary material.
